(19) United States
(12) Patent Application Publication
(10) Pub. No.: US 2008/0151998 A1
(43) Pub. Date: Jun. 26, 2008

(54) Method and Apparatus for Providing Rate Control for Panel-Based Real Time Video Encoder

(75) Inventor: Yong He, San Diego, CA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/614,256

(22) Filed: Dec. 21, 2006

(51) Int. Cl. H04B 1/66

(52) U.S. Cl. 375/240.03

(57) ABSTRACT

A method and apparatus is provided for panel-based rate control in an MPEG encoder. In one embodiment, the method begins by estimating a complexity measure of pictures in a GOP and calculating a GOP bit budget for the GOP. Portions of the GOP bit budget are assigned to the pictures in the GOP based at least in part on the estimated complexity measure. A quantization parameter is adjusted for the picture to achieve the assigned portion of bit budget for each picture in the GOP.

### FIELD OF THE INVENTION

The present invention relates to video processing, and more particularly to a method and apparatus for controlling the rate of data production by multiple encoding engines provided to compress video in an MPEG encoder.

### BACKGROUND OF THE INVENTION

Rate control is an essential part of a video encoder. In an MPEG encoder, the picture is processed using multiple encoding engines for data compression. These multiple encoding engines operate on the picture simultaneously, but share a common data buffer. Thus, the rate at which data is produced by the multiple engines must be carefully regulated in order to prevent buffer overflow, buffer underflow, and other problematic conditions. A rate control algorithm dynamically adjusts encoder parameters to achieve a target bitrate. It allocates a budget of bits to each group of pictures, individual pictures and/or sub-pictures in a video sequence.

Currently available rate control schemes do not provide a robust solution to the problem of regulating the rate of data production by a plurality of compressors in order to control the quantization of a digital video encoder that uses parallel compression engines. For example, in copending U.S. app. Ser. No. [BCS03960] the complexity of a current picture is assumed to be equal to the complexity of the previously coded picture of the same type (e.g., I, P or B). This may cause abrupt complexity changes, which results in unstable complexity estimation. In addition, certain delays are inevitable among the coding stages of a real-time MPEG encoder system. The actual number of bits consumed for each frame or macroblock may not be available in time to calculate the bit budget, adjust quantization parameters, and protect encoder and decoder buffer from overflows and underflows. BCS03960 assumes that all the rate control parameters are available when needed, which is generally not true for a real-time encoder system. In addition, U.S. appl. Ser. No. [BCS03960] presents a simple buffer protection method. A real-time panel-based MPEG encoder system, typically requires at least 3 frame times for all the encoding engines to finish encoding one frame. Such delay makes buffer protection more complex and should be taken into account in the rate control methodology.

Accordingly, it would be advantageous to provide an efficient rate control algorithm to regulate the rate of data production by multiple encoding engines to optimize video quality.

### SUMMARY OF THE INVENTION

In accordance with the present invention, a method and apparatus is provided for panel-based rate control in an MPEG encoder in which the aforementioned problems and limitations are overcome. In one embodiment, the method begins by estimating a complexity measure of pictures in a GOP and calculating a GOP bit budget for the GOP. Portions of the GOP bit budget are assigned to the pictures in the GOP based at least in part on the estimated complexity measure. A quantization parameter is adjusted for the picture to achieve the assigned portion of the bit budget for each picture in the GOP.

In accordance with one aspect of the invention, encoder and decoder buffers may be prevented from overflowing or underflowing before encoding a picture in the GOP.

In accordance with another aspect of the invention, the buffers may be prevented from overflowing or underflowing by estimating a current buffer level.

In accordance with another aspect of the invention, the buffers may be prevented from overflowing or underflowing by calculating a number of bits in the pictures that do not overflow or underflow the buffers using an end-to-end buffer delay.

In accordance with another aspect of the invention, the GOP bit budget may be calculated by assuming that a film mode of the GOP is the same as a film mode of a previously processed picture.

In accordance with another aspect of the invention, the quantization parameter may be adjusted using a nominal activity measure.

### BRIEF DESCRIPTION OF THE DRAWINGS

FIG. 1 is a block diagram of one example of a MPEG-4 encoder.

FIG. 2 is a flow chart illustrating a rate control process for real-time video encoding using a multi-panel based encoder such as the encoder depicted in FIG. 1.

FIG. 3 illustrates the manner in which the complexity of the current picture is estimated using the complexity values of the four previously encoded frames of the same type.

FIG. 4 illustrates how the encoder buffer is updated when three frame times are needed to transfer the bits of current picture into the encoder buffer.

FIG. 5 shows illustrates how the video buffer level is estimated using the expected video FIFO level.

FIG. 6 illustrates how the maximum frame or picture size that prevents buffer underflow is determined using the number of bits available for the current frame or picture.

FIG. 7 is a diagram of the geometric positions of MBs currently being processed by the panels.

### DETAILED DESCRIPTION

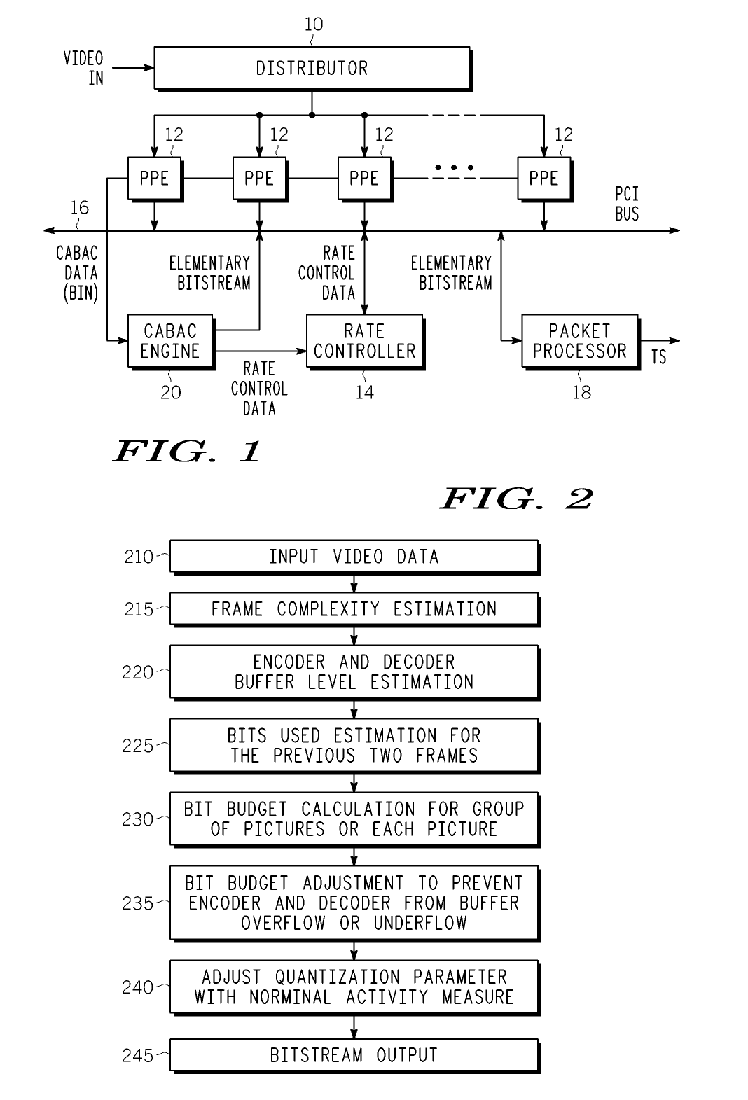

A method and apparatus is provided for rate control in a digital video encoder that uses multiple compression engines running in parallel. FIG. 1 shows one example of digital video encoder such as an MPEG 4 encoder. In accordance with a preferred embodiment of the invention as illustrated in FIG. 1, every input picture of a video stream is partitioned into multiple horizontal panels by a panel distributor 10. Each panel is then compressed by individual video panel picture encoders (PPEs) 12, which may be, for example, general purpose DSPs. It should be appreciated that a different number of panels can be utilized, and that the techniques described herein can be implemented on video encoders other than the encoder described herein.

The panels into which the input pictures are partitioned are compressed during a frame time. Specifically, the first panel is compressed first, the second panel begins to be compressed after certain coding information is available from the first panel, and so for the rest of the panels. The compressed panel data are stored locally on the panel compressor, and then transferred to a packet processor 18. The packet processor 18 forms a transport packet in accordance with the well known MPEG (Motion Picture Experts Group) standard. As illustrated in FIG. 1, packet processor 18 outputs the compressed bitstream.

The rate control function is performed by a rate controller 14. The rate controller 14 collects statistics from the panel compressors and the buffer level from the video FIFO, and then calculates an 8 bit reference quantizer scale for each panel compressor. The panel compressor then modifies the reference quantizer scale based on local activities and local buffer fullness to generate the final quantizer scale value to use for quantization.

The goal of rate control is to maintain a consistent video quality over time and over the picture. A basic assumption of the rate control algorithm is that the coding complexity of a particular picture type is approximately constant from frame to frame of a steady scene, and is measured by the product of the average quantizer scale and the number of bits generated over the frame (or a panel). The complexity of the current frame is normally estimated from that of the previous frame, except a when a scene change or fade-in from black is detected, in which case the complexity estimates are reset or scaled to some provisional values. Among other things, the rate control techniques described herein provide a stable estimation of the complexity measure using a weighted averaging method and can estimate the rate control parameters (e.g., actual number of bits consumed for each frame, quantization parameters) at different coding stages.

The rate controller 14 determines the initial target bit rate of the picture and the picture target quantizer scale QP for each PPE 12 and sends the rate control information to each PPE 12 through the PCI bus 16. Each PPE 12 performs the video compression on its own panel and exchanges the rate control information with the rate controller 14 to periodically adjust the coding rate and the QP. The PPEs 12 will send the CABAC (Context-Adaptive Binary Arithmetic Coding) data that is generated to a CABAC engine 20, which uses binary arithmetic coding as part of the encoding process. The CABAC data from the PPEs is converted by the CABAC engine 20 into the final bitstream as a video elementary stream.

The engine 20 takes one extra frame time to convert the CABAC data (called bins) to final bits, and sends the final number of bits to the rate controller 14.

Rate control by the rate controller 14 is performed in two parts. First, the rate controller 14 performs rate control at the picture level to determine the bits available for the current group of pictures (GOP) based on the number of frames and fields and their corresponding complexities. The rate controller 14 then adjusts the number of GOP bits when a special event (e.g., a scene change) arises and determines a target number of bits bits for the picture and the QP for each PPE. During the PPE encoding process, the rate controller 14 periodically receives the coding statistics from the PPEs, and using the statistics as feedback, adjusts the quantizer scale for each PPE 12. The PPE 12 modifies the reference quantizer scale based on local activities and local buffer fullness to generate the final quantizer scale value to be used for quantization.

FIG. 2 is a flow chart illustrating a rate control process for real-time video encoding using a multi-panel based architecture. The process may be performed by a real-time video encoder such as an MPEG-4 encoder. The process begins in step 210 with reception of video input data by a video encoder. In step 215 the frame complexity is estimated. The complexity measure is defined as the product of the number of bits used for a I, P or B picture and the associated coding distortion. Next, in step 220 the encoder and decoder buffer status is updated by estimating the current buffer level so that at another point in the process the overflow and underflow of both the encoder and decoder buffers can be prevented. Since two frame times are required to complete the encoding of one frame by each PPE, an estimate of the number of bits used for the previous two frames is used in step 225 to obtain the current buffer level.

A bit budget is calculated for each GOP or picture in step 230. To calculate the bit budget a number of target bits is assigned per GOP, and per picture of each type. The number of target bits that are assigned to a GOP will be determined in part by assuming that the film mode of the GOP will be same as the last processed picture. That is, if the previous picture was in film mode, the current GOP is assumed to be in film mode. Likewise, if the previous picture was in non-film mode, the current GOP is assumed to be in non-film or video mode. Once the bit budget per GOP is determined, the pictures within the GOP need to be assigned a target number of bits based on picture type (I, P or B) and their relative complexity measure. An interlaced picture comprising two fields can be encoded as a single frame picture or as two separate field pictures. The rate control algorithm maintains two sets of the complexity measure, one for frame pictures and one for field pictures. It should be noted that in a real-time system, certain delays are inevitable. For example, the actual number of bits allocated for a given picture many not be available until three or four pictures later. Hence, the picture complexities used in the calculating the target number of bits per picture in a frame or field may be the ones calculated a few pictures away in the past.

The bit budget calculated in the previous steps may be adjusted in step 235 to prevent the encoder and decoder buffers from overflow or underflow. The rate controller uses an end-to-end buffer delay to calculate the maximum available number of bits in the picture that does not overflow the encoder buffer or underflow the decoder buffer. The end-to-end buffer delay is a constant that is defined as the hypothetical lapsed time from when the first bit of picture enters the encoder FIFO buffer to the time the picture is pulled out from the decoder buffer FIFO. To prevent the decoder buffer from underflow, all the bits currently in the encoder buffer plus the bits to be generated for the current frame has to be transported to the decoder before the decode time of the current frame. To prevent the encoder buffer from overflow, the expected level the expected level of the video FIFO at the end of the current frame time should not exceed the size of the video FIFO. The expected level of the video FIFO equals the current FIFO level plus the size of the frame to be generated minus the number of bits leaving the FIFO during the frame time.

Given the final total bit budget determined in step 235, the quantization parameter QP is adjusted in step 240 so that the number of bits approaches the bit budget. A feedback mechanism is used such that the accumulated bit/bins count of the picture is compared to the target bit rate of the picture scaled by the portion of the macroblocks (MB) encoded. The quantization parameter is adjusted using the nominal activity measure. The quantization parameter is adjusted in this manner so that more bits are allocated to complex parts of the picture in comparison to simpler parts of the picture.

Once the quantization parameter has been determined the compressed bitstream can be generated by the PPEs and output by the packet processor in step 245.

The following sections detail the operation of the rate control algorithm.

LIST OF VARIABLES

| Name | Default value | description |
|---|---|---|
| R | N/A | total number of bits generated per frame |
| D | N/A | Sum of square error per frame |
| C_{picture type} | N/A | Coding complexity estimation per frame |
| W | {1, 2, 2, 4} | Complexity weighting of P and B frames |
| PictureDuration | N/A | Estimated duration of current picture |
| EncoderBufferLevel[n] | N/A | Total number of bits to be store in the encoder |
| | | buffer at frame n |
| EncoderFifoLevel | N/A | Total number of bits currently in the encoder |
| | | buffer |
| FrameBitsCount[n] | N/A | Estimated bits used for frame (n − 1) and (n − 2) |
| Vbv_fullness | N/A | Virtual buffer level |
| DelayBits | N/A | Number of bits transferred during the system |
| | | delay time |
| systemDelay | N/A | Total buffer delay of encoder and decoder |
| | | buffer |
| AvgTxbitRate | N/A | Average transport rate |
| cabacBins | N/A | Number of bits generated by CABAC |
| CABAC | | Context-adaptive binary arithmetic coding |
| | | defined in H.264/MPEG-4 AVC standard |
| Alpha | N/A | Final bits to cabacBins ratio |
| BitBudget[n] | N/A | Bit budget for frame n |
| HeaderBitCount | N/A | Number of bits used for syntax header |
| PictNominalSentBits | N/A | Nominal number of bits transferred from |
| | | encoder to decoder buffer |
| Bit_rate | N/A | Encoding bit rate |
| ExpectedVideoFifoLevel | N/A | Estimated encoder buffer level at the end of |
| | | current frame time. |
| GopDuration | N/A | Estimated duration of current GOP |
| F_{film factor} | N/A | Scale factor for film mode |
| N_{gop} | User define | Number of frames in the current GOP |
| Pic_rate | User define | Frame rate of input video |
| β | N/A | Control scale factor |
| R_{gop} | N/A | Bit budget for the current GOP |
| FrameMaxDecoder | N/A | Maximum number of bits the current frame is |
| | | allowed to generate, as constrained by decoder |
| | | buffer |
| FrameMaxEncoder | N/A | Maximum number of bits the current frame is |
| | | allowed to generate, as constrained by encoder |
| | | buffer |
| Rmax | N/A | Maximum bit budget allowed |
| Rmin | N/A | Minimum bit budget allowed |
| R_{frame}_target | N/A | Target number of bits to be generated by the |
| | | current frame in frame mode |
| R_{field}_target | N/A | Target number of bits to be generated by the |
| | | current frame in field mode |
| d_{pic type}(t) | N/A | Virtual buffer fullness at time t |
| B_{pic type}(t) | N/A | Number of CABAC bins generated at time t |
| Nbs | N/A | Nominal buffer size |
| Intra_act_ave | N/A | Local average macroblock activity |
| Total_intra_act | N/A | Total macroblock activity |
| Qstep | N/A | Quantization step |
| QP | N/A | Quantization parameter |

### Update the Complexity Estimation of Current Picture (e.g., Step 215 in FIG. 2)

The rate controller 14 collects the picture bit count R and the associated coding distortion D from previous coded pictures for estimating the complexity of current picture.

R=total number of bits generated by the picture. (1)

D=sum of square error (SSE). (2)

C_{pic}_{_{—}}_{type}=R*D (3)

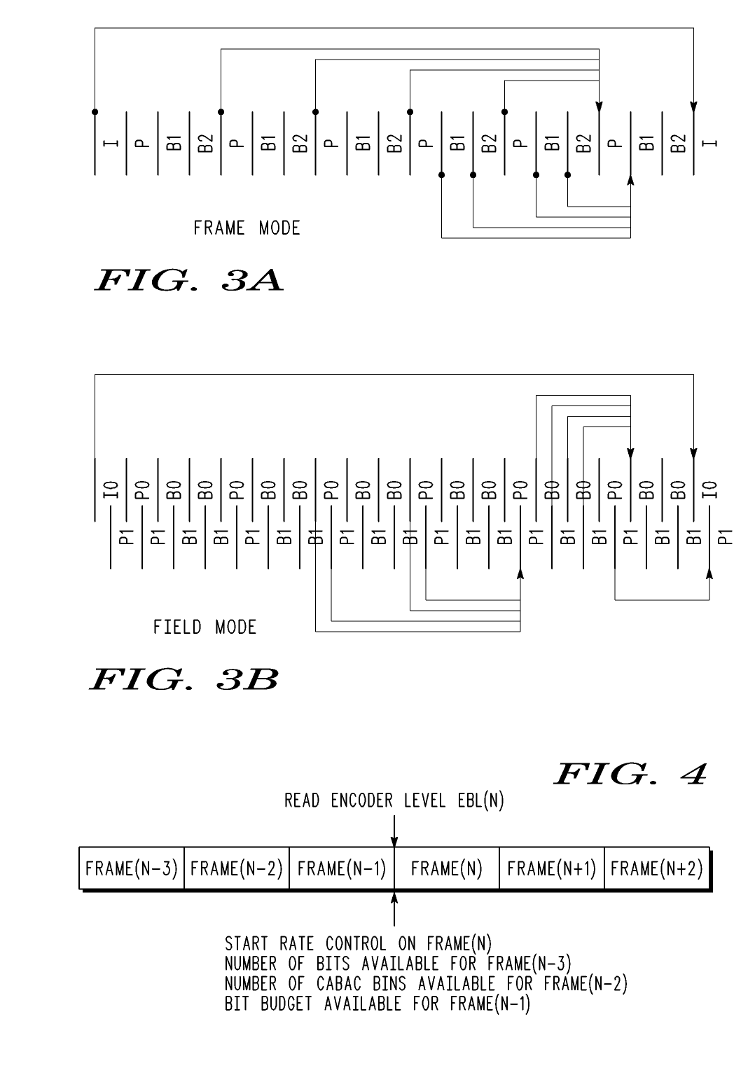

The complexity of last Intra coded frame is used for I frame, and four most recently coded frames of the same picture type are used to generate the complexity estimate for P and B frames. Averaging more frames provides more stable complexity estimate but slower response time. As indicated in FIG. 3, the rate control algorithm maintains a queue to store the complexity values of the four most recently coded P frames, and a queue to store the complexity values of the four most recently coded B frames. The complexity estimate for P (or B) frame, Cₚ (or C_{b}), is then calculated as the weighted average of the 4 complexity values stored in the P (or B) complexity queue.

Each frame can be coded in frame mode or field mode. In field mode, the top field of I frame is coded as I0 field, and bottom field of I frame is coded as P1 field. I frames occurs infrequently, therefore, the most recent I0 field or I frame complexity is used as the complexity estimation of current I0 field or I frame, and the most recent P1 field complexity is used as complexity estimation of current P1 field. Please note that the for B2 frame, the previous B1 encoded bits count is not available for B2 complexity estimation due to the panel based coding architecture.

Define a sequence of weightings W={1, 2, 2, 4} and the complexity of current P or B frame is:

$${C}_{pic\_type} = \frac{W ⊗ {C}_{pic\_type}^{*}}{\sum W} ;$$

where C* is the complexity of previous frames with same coded type.

Note that a picture is encoded only once, either in frame mode or field mode depending on the picture coding mode decision. However, two separate frame and field complexity measures, denoted field complexity and frame complexity, are updated for each picture and the method is described later. The estimated complexities are used to calculate the target bit budget for upcoming frames to be encoded.

### Update the Encoder's Buffer Status (e.g., Step 220 in FIG. 2)

Initially, the encoding duration (PictureDuration) of the current frame is calculated.

For film mode, PictureDuration equals (1.5/pic_rate) if the current picture to be encoded has repeat first field, otherwise PictureDuration equals (1.0/pic_rate).

Then the total encoder buffer level is computed as

EncoderBufferLevel[n]=EncoderFifoLevel+FrameBitCount[n] (4)

The FrameBitCount[n] is the bits count for the previous 2 pictures, which is unknown at the moment, thus, the target bits budget and CABAC bins are used here instead.

FrameBitCount[n]=BitBudget[n−1]+alpha*FrameCabacBins[n−2]+HeaderBitCount (5)

alpha is the final bits to CABAC bins ration which is calculated from previous frame of same picture type. FrameCabacBins is the number of bins left in the CABAC engine buffer

Since PPEs have to spend 2 frames time to complete one frame encoding, and CABAC engine takes one more frame time to convert CABAC Bin to elementary bits and transfers the bits to the encoder buffer in packet processor. As shown in FIG. 4, in total it takes 3 frames time to dump the bits of current coding frame into the encoder buffer before it is transported. The EncoderFifoLevel read from the packet processor does not include the number of bits consumed for the previous 2 pictures.

Therefore, when update encoder buffer and VBV buffer level to calculate ExpectedVideoFifoLevel, only target bit budget is available for previous frame (n−1), and CABAC bins are available for the frame before previous frame.

The VBV buffer fullness is updated:

Vbv_fullness=DelayBits−EncoderBufferLevel[n]

Where DelayBits=(systemDelay+3*PictureDuration)*AvgTxBitRate.

The number of bits transmitted over the upcoming frame time is calculated by

PictNominalSentBits=3*PictureDuration*(AvgTxBitRate) (6)

For fixed rate operation, the transmission bit rate is the same as the encoding bit rate (bit_rate) which is a user configured parameter.

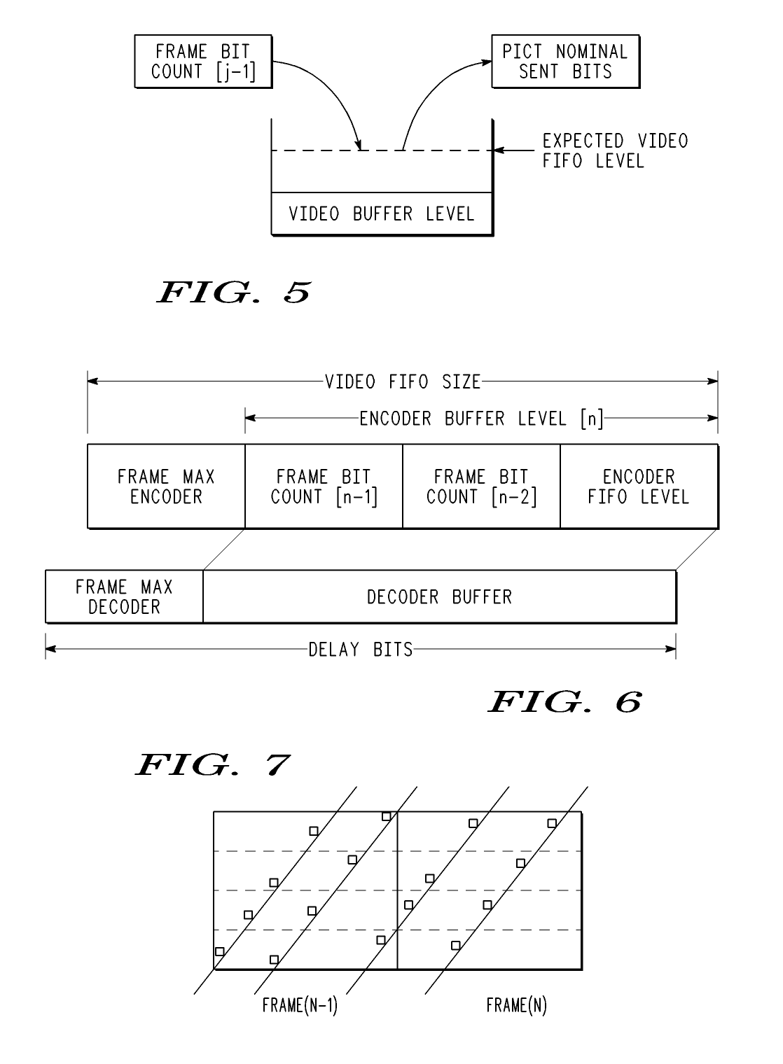

As shown in FIG. 5, the expected video FIFO level at the end of the frame time is then estimated by

ExpectedVideoFifoLevel=EncoderBufferLevel[n]−PictNominalSentBits (7)

The packet processor inserts null packet when the encoder buffer is empty.

### Target Bits Per GOP (e.g., Step 230 in FIG. 2)

Before encoding an I frame, the rate controller calculates the bit budget for the new GOP, assuming a nominal number of frames for the GOP (N_{GOP}).

The rate controller estimates the time duration of the upcoming GOP (GopDuration) based on its film status. When the initial GOP target bit budget is calculated at the beginning of the GOP, it is assumed that the entire GOP will operate in film mode if the last processed picture is film; or in regular video mode if the last processed picture is non-film.

In the case of film mode, a film mode factor (f_{film}_{_{—}}_{factor}) is used to scale the picture rate (pic_rate) in video versus film. f_{film}_{_{—}}_{factor} is 1.25 for 1080I mode, and 2.5 for 720P mode.

Given a target bit rate of bit_rate in bits per second and a picture rate of pic_rate in pictures per second, a GOP of pictures is budgeted a nominal number of bits as

$${R}_{GOP} = {f}_{film\_factor} \times {N}_{GOP} \times \frac{bit\_rate}{pic\_rate} , \\ {f}_{film\_factor} = \{ \begin{matrix}1.0 & video mode & \\ 1.25 & 1080 I & film mode \\ 2.5 & 720 P & film mode\end{matrix} \} \qquad ( 8 )$$

In constant bit rate mode, the bit_rate equals to the transmission bit rate which is specified by the user. In Statpacket mode, the host processor assigns the encoding bit rate which is determined by the Statpacket group controller.

At the beginning of a GOP, a target number of bits R_{GopTarget} is set as,

R_{GopTarget}=β*R_{GOP}_{_{—}}_{remaining}+R_{GOP} (9)

where R_{GOP}_{_{—}}_{remaining} on the right is number of bits carried over from the previous GOP. β is an adaptive feedback control factor such that β=1.0 when there are surplus bits carried over from the previous GOP (R_{GOP}_{_{—}}_{remaining}>0) and β=0.75 when there are deficit (R_{GOP}_{_{—}}_{remaining}<0). This arrangement allows the rate control algorithm to response quickly to make use of the unused bit (if any) left over from previous GOP, yet avoids starving the new GOP if the previous GOP consumes more bits than the budget. Thus any negative feedback is absorbed by the buffer and spread over future GOPs to avoid sudden degradation in the video quality. For the first GOP of a sequence, R_{GOP}_{_{—}}_{remaining} on the right is set to 0 bits.

If the current frame count with respect to the start of the GOP is less than the nominal GOP length, N_{GOP} is set to the same value as the nominal GOP length. If the current frame count exceeds the nominal GOP length, N_{GOP} is increased by M frames for every time a P frame is encountered.

This adjustment is only done on P frames since extra B frames must be accompanied by P frames, and the increment is

$$( {f}_{film\_factor} * M * \frac{bit\_rate}{pic\_rate} ) .$$

When the input sequence switches between film and non-film, the duration of the GOP and R_{GopTarget} will also change. The effect of this change is described below in the calculation of the picture target rate.

### Buffer Protection (e.g., Step 235 in FIG. 2)

The end-to-end buffer delay is a constant defined as the hypothetical lapsed from the time the first bit of the picture enters the encoder FIFO to the time the picture is pulled out from the decoder FIFO (DTS of the picture). The rate controller rate control algorithm uses the delay value to calculate the maximum allowable number of bits in the picture that does not overflow the encoder buffer or underflow the decoder buffer.

In fixed bit rate, we let the system store as many bits as the decoder buffer allows to maximally utilize the buffers at high bit rate. We set an upper bound of 1 second delay to ensure a reasonable channel acquisition delay.

To prevent the decoder buffer underflow, all the bits currently in the encoder buffer plus the bits to be generated for the current frame has to be transported to the decoder before the decode time of the current frame. Therefore, with reference to FIG. 6, the number of bits available for the current frame is

FrameMaxDecoder=DelayBits−(Max(EncoderBufferLevel[n], PictNominalSentBits)) (10)

Where DelayBits=(systemDelay+3*PictureDuration)*AvgTxBitRate;

To prevent the encoder's video FIFO from overflow, the expected level of the video FIFO (current FIFO level plus the size of the frame to be generated minus the number of bits leaving the FIFO during 3 frame time) at the end of the current frame time should not exceed the size of the video FIFO (VideoFifoSize).

FrameMaxEncoder=VideoFifoSize−ExpectedVideoFifoLevel (11)

The size of the video FIFO is 50 Mbits.

Then the maximum allowable bitstream size of the current frame is calculated as the smaller of FrameMaxEncoder and FrameMaxDecoder. Safety margins (100 Kbits for decoder, and 500 Kbits for encoder) are subtracted from these limits.

Rₘₐₓ=MIN(FrameMaxEncoder−encMargin, FrameMaxDecoder−decmargin) (12)

Where encMargin=500000, and decMargin=100000.

Rₘᵢₙ=PictNominalSentBits−ExpectedVideoFifoLevel (13)

### Target Rate per Picture (e.g., Step 230 in FIG. 2)

For every picture to be encoded, the rate controller rate control algorithm calculates a target for the number of bits to be generated for the frame (R_{pic}_{_{—}}_{target}) Given a target number of bits for a GOP, R_{GopTarget}, a picture of pic_type I, P or B is assigned a target number of bits, R_{pic}_{_{—}}_{target}, according to its relative complex measure, C_{pic}_{_{—}}_{type}, over other pictures within the current GOP.

An interlace picture of two fields can be encoded as a single frame picture or as two separate field pictures. H.264 allows adaptive switching between frame and field picture coding. The rate control algorithm therefore maintains two sets of the complexity measures of pic_type I, P and B pictures. One is for frame pictures and the other is for field pictures.

For a frame picture, the target number of bits is set as

$${R}_{frame\_target} = \frac{{K}_{pic\_type} {C}_{pic\_type} {R}_{Gop\_remaining}}{\begin{matrix}{K}_{I} {n}_{frame\_I} {C}_{frame\_I} + \\ {K}_{P} {n}_{frame\_P} {C}_{frame\_P} + {K}_{B} {n}_{frame\_B} {C}_{frame\_B}\end{matrix}} \qquad ( 14 )$$

and for a field picture, the target number of bits is set as

$${R}_{field\_target} = \frac{{K}_{pic\_type} {C}_{pic\_type} {R}_{Gop\_remaining}}{\begin{matrix}{K}_{I} {n}_{field\_I} {C}_{fieldI} + \\ {K}_{P} ( {n}_{field 0 \_P} {C}_{field 0 \_P} + {n}_{field 1 \_P} {C}_{field 1 \_P} ) + \\ {K}_{B} {n}_{field\_B} {C}_{field\_B}\end{matrix}} \qquad ( 15 )$$

where
pic_type indicates the picture type of I, P or B for the current picture.
C_{frame}_{_{—}}_{I}, C_{frame}_{_{—}}_{P}, and C_{frame}_{_{—}}_{B} are the complex measures for frame pictures of pic_type I, P and B, respectively. C_{field}_{_{—}}_{I}, C_{field0}_{_{—}}_{P}, C_{field1}_{_{—}}_{P}, C_{field}_{_{—}}_{B} are the complex measures for I field, P field 0, P field 1 and B field pictures, respectively.
K_{I}, K_{P} and K_{B} are the pre-set constants for pictures of pic_type I, P and B, respectively. For example, K_{I}=K_{P}=1 and K_{B}=1/1.4.
n_{frame}_{_{—}}_{I}, n_{frame}_{_{—}}_{P}, and n_{frame}_{_{—}}_{B} are the remaining numbers of I, P and B frame pictures in the current GOP. n_{field}_{_{—}}_{I}, n_{field0}_{_{—}}_{P}, n_{field1}_{_{—}}_{P}, and n_{field}_{_{—}}_{B} are the remaining numbers of I field, P field 0, P field 1 and B field pictures in the current GOP.

After encoding a picture of I, P or B, the remaining number of bits for the current GOP is updated as,

R_{GOP}_{_{—}}_{remaining}=R_{GOP}_{_{—}}_{remaining}−R_{target}. (16)

where R_{target} is the frame/field target bits of the current picture. Once the actual number of bits consumed is available, R_{GOP}_{_{—}}_{remaining} has to be updated accordingly as following:

R_{GOP}_{_{—}}_{remaining}=R_{GOP}_{_{—}}_{remaining}+R_{target}−R_{pic}_{_{—}}_{bits}. (17)

Please also note that in field coding mode, each PPE processes field0 and field1 simultaneously within the panel. The number of field0 bits are not available before calculating field1 target bits. In this case, the field0 target bits is used to update R_{GOP}_{_{—}}_{remaining} for field1 target bit rate calculation, and R_{GOP}_{_{—}}_{remaining} has to be updated once estimated bits is available.

Another real-time implementation issue has to be addressed is that the number of bits of previous 2 pictures are not available because PPE processing is across up to 2 pictures. At the moment of picture (N+1), (N+2) and (N+3), some PPEs may finish the panel encoding, while others may not. Therefore, the target bits and the number of CABAC bins of previous 2 pictures are used for updating vbv buffer. Once the real bits used by the picture are available, the estimated bits based on the target bits and number of bins has to be replaced immediately.

If the picture is coded as frame mode, its frame complexity can be obtained by equation (3), and its relative field complexity can be retrieved from equation (24). If the picture is coded as field mode, its field complexity of field0 and field 1 can be obtained by equation (3), and its relative frame complexity can be retrieved by equation (24).

C_{field0}_{_{—}}_{P}=C_{frame}_{_{—}}ₚ*2/3; C_{field1}_{_{—}}_{P}=C_{frame}_{_{—}}_{P}/3; C_{field0}_{_{—}}_{B}=C_{frame}_{_{—}}_{B}/2 (18)

C_{frame}_{_{—}}_{I}=C_{field}_{_{—}}_{I}*2; C_{frame}_{_{—}}_{P}=C_{field1}_{_{—}}_{P}*3; C_{frame}_{_{—}}_{B}=C_{field}_{_{—}}_{B}*2 (19)

At the beginning of a GOP, the remaining numbers of I, P and B frame and field pictures for the current GOP are set as,

n_{frame}_{_{—}}_{P}=Nₚ; n_{frame}_{_{—}}_{B}=N_{B}; (20)

if I in field mode is configured to be coded as I field 0 followed by P field 1 (as designed in phase 1),

n_{field0}_{_{—}}_{I}=n_{field0}_{_{—}}_{P}=Nₚ; n_{field1}_{_{—}}_{P}=Nₚ+1; n_{field}_{_{—}}_{B}=2*N_{B} (33)

After a frame picture of I, P or B is encoded, the corresponding number of I, P or B pictures in the current GOP is updated as, if (I) and I is configured to be coded as I field 0 followed by P field 1,

n_{frame}_{_{—}}_{I}−−; n_{field}_{_{—}}_{I}−−; n_{field1}_{_{—}}_{P}−−; (21)

else if(P) n_{frame}_{_{—}}_{P}−−; n_{field0}_{_{—}}_{P}−−; n_{field1}_{_{—}}_{P}−−; (22)

else n_{frame}_{_{—}}_{B}−−; n_{field}_{_{—}}_{B}−=2; (23)

After field 0 of I, P, or B is encoded, the corresponding number of I, P or B pictures in the current GOP is updated as,

if (I) n_{field}_{_{—}}_{I}−−; (24)

else if (P) n_{field0}_{_{—}}_{P}−−; (25)

else n_{field}_{_{—}}_{B}−−; (26)

After field I of P, or B is encoded, the corresponding number of P or B pictures in the current GOP is updated as,

if (P picture)

if field 0 is coded as I, n_{frame}_{_{—}}_{I}−−; (27)

if field 0 is coded as P field, n_{frame}_{_{—}}_{P}−−; (28)

n_{field1}_{_{—}}_{P}−−; (29)

else (B picture)

if field 0 is coded as I, n_{frame}_{_{—}}_{I}−−; (30)

if field 0 is coded as B, n_{frame}_{_{—}}_{B}−−; (31)

n_{field}_{_{—}}_{B}−−; (32)

To avoid extreme values that may result from inaccurate complexity estimate, hard limits are provided so that R_{frame}_{_{—}}_{target} would not exceed upper limit or go below this limit.

R_{frame}_{_{—}}_{target}=Min(R_{frame}_{_{—}}_{target},Rₘₐₓ) (33)

R_{frame}_{_{—}}_{target}=Max(R_{frame}_{_{—}}_{target},Rₘᵢₙ) (34)

In case of field coding mode,

If R_{field0}_{_{—}}_{target}+R_{field1}_{_{—}}_{target}>Rₘₐₓ,

R_{field}_{_{—}}_{target}=R_{field}_{_{—}}_{target}−(ΣR_{field}_{_{—}}_{target}−Rₘₐₓ)/2 (35)

If (R_{field0}_{_{—}}_{target}+R_{field1}_{_{—}}_{target})<Rₘᵢₙ

R_{field}_{_{—}}_{target}=R_{field}_{_{—}}_{target}+(Rₘᵢₙ−ΣR_{field}_{_{—}}_{target})/2 (36)

### MB Level Rate Control (e.g., Step 240 in FIG. 2)

Ideally the picture target quantizer scale (QP) should be used throughout the picture to produce a uniform quality over the entire picture. However the rate control model based on the frame/field complexity estimate is not always accurate so adjustment to QP is necessary to control the bit rate. A feedback mechanism is used such that the accumulated bit/bins count of the picture is compared to the target bit rate of the picture scaled by the portion of macroblocks coded. The target number of bits per (frame or field) PPE can be achieved by properly selecting value of QP per MB.

H.264 | MPEG-4 AVC allows a total of 52 possible values in quantization parameter (QP) They are 0, 1, 2, . . . , 51. The target number of bits per frame or field can be achieved by properly selecting value of QP per MB or a group of MBs.

Given the target numbers of bits for (frame or field) pictures of pic_type I, P and B, R_{pic}_{_{—}}_{type}, the rate controller first determines three reference (not final) quantization parameters, QP_{pic}_{_{—}}_{type}(t), at a time instant t based upon the fullness of three virtual buffers, one for each picture types of pic_type. The virtual buffer fullness of pic_type I, P or B at time t is computed as

$${d}_{pic\_type} ( t ) = {d}_{pic\_type} ( 0 ) + α \times {B}_{pic\_type} ( t ) - \frac{{\sum }_{i = 0}^{{MB}_{i}} {nbs}_{i}}{total\_nbs} {R}_{pic\_target} \qquad ( 43 )$$

where
d_{pic}_{_{—}}_{type}(0) is the initial virtual buffer fullness at the beginning of the picture of pic_type I, P or B. The final virtual buffer fullness of the current picture, d_{pic}_{_{—}}_{type}(t), is used as d_{pic}_{_{—}}_{type}(0) for the next picture of the same pic_type,
B_{pic}_{_{—}}_{type}(t) is the number of bins generated from the coded MBs among all the PPEs in the picture of pic_type up to time t. Note that it is possible that at the beginning of a MB row, the final QP value of the last MB in the above MB row is unknown. The bin count for mb_qp_delta for the first MB in a MB row therefore is not available. In this case, a bin count (for example, 0) may have to be assumed for mb_qp_delta in order to get the total bit count for the first MB in a MB row. This is also an issue for the rate controller or any other devices that maintain and deliver the bins to the arithmetic code engine.
α is the ratio of the total number of actual bits and the total number of bins for the previously-coded picture of the same coding type. For the first I, α is set as 0.75, for the first P, set to be the same as that of the previous I, and for the first B, set to be the same as that of the previous P. α is reset at each scene cut.

The Nominal Buffer Size (nbs[i]) for a macroblock is calculated during preprocessing from the total activity Total_Intra_Act[i] for that macroblock and the average of the total activity (Intra_Act_Ave) for the segment as follows:

$$\begin{matrix}{nbs}_{i} = \frac{α \times Intra\_Act [ i ] + Intra\_Act \_Ave}{α \times Intra\_Act \_Ave + Intra\_Act [ i ]} \\ = \frac{α \times ( \frac{Intra\_Act [ i ]}{Intra\_Act \_Ave} ) + 1}{α + ( \frac{Intra\_Act [ i ]}{Intra\_Act \_Ave} )}\end{matrix} \qquad ( 37 )$$

where the average of the total intra activity (Intra_Act_Ave) is the total activity (Total_Intra_Act) divided by the number of macroblocks in the frame. The purpose of NBS is to spend more bits in complex part of the picture than in simple part.

The quantization step Qstep at time t is set proportional to the fullness of virtual buffer as,

Qstep_{pic}_{_{—}}_{type}(t)=51×d(t); (38)

Then, the QP is calculated as following:

QP=[6*log₂(Qstep_{pic}_{_{—}}_{type})+c]; c=4 (39)

In H.264|MPEG4 AVC, before a MB can be processed, the coded information of its left and above neighbor MBs have to be available. Hence, the geometric positions of the current MBs in PPEs may not be the same, as shown in FIG. 6, where the shaded blocks are the current MBs. In addition, the upper PPEs may complete the processing of their MBs much earlier than the lower PPEs, and move on to the MBs in next picture. For most resolutions, the PPE processing crosses 2 pictures, and each picture has different types of I, P and B. Hence, the rate controller needs to have the target numbers of bits ready for all the three picture types of I, P and B all the time. And 2 virtual buffers d_{pic}_{_{—}}_{type}(N), d_{pic}_{_{—}}_{type}(N+1) and d_{pic}_{_{—}}_{type}(N+2) are calculated separately for frame coding mode and 6 virtual buffer for field mode, which results maximum 6 separate Q in field mode.

1. At least one computer-readable medium encoded with instructions which, when executed by a processor, performs a method comprising:
estimating a complexity measure of pictures in a GOP;
calculating a GOP bit budget for the GOP;
assigning portions of the GOP bit budget to the pictures in the GOP based at least in part on the estimated complexity measure; and
adjusting a quantization parameter for the picture to achieve the assigned portion of bit budget for each picture in the GOP.

2. The computer-readable medium of claim 1 further comprising preventing encoder and decoder buffers from overflowing or underflowing before encoding a picture in the GOP.

3. The computer-readable medium of claim 2 wherein preventing of the buffers from overflowing or underflowing includes estimating a current buffer level.

4. The computer-readable medium of claim 2 wherein preventing of the buffers from overflowing or underflowing includes calculating a number of bits in the pictures that do not overflow or underflow the buffers using an end-to-end buffer delay.

5. The computer-readable medium of claim 1 wherein calculating the GOP bit budget includes assuming a film mode of the GOP is the same as a film mode of a previously processed picture.

6. The computer-readable medium of claim 1 wherein the quantization parameter is adjusted using a nominal activity measure.

7. The computer-readable medium of claim 1 wherein estimating the compexity measure includes determining the complexity measure of P and B pictures in accordance with the expression
$${C}_{pic\_type} = \frac{W ⊗ {C}_{pic\_type}^{*}}{\sum W} ,$$
where C* is the complexity of a previously encoded picture of the same type and W is a sequence of weightings W={1, 2, 2, 4}.

8. The computer-readable medium of claim 1 wherein calculating the GOP bit budget includes assigning a nominal number of bits to the GOP in accordance with the expression
$${R}_{GOP} = {f}_{film\_factor} \times {N}_{GOP} \times \frac{bit\_rate}{pic\_rate} , \\ {f}_{film\_factor} = \{ \begin{matrix}1.0 & video mode & \\ 1.25 & 1080 I & film mode \\ 2.5 & 720 P & film mode\end{matrix} \}$$

9. The computer-readable medium of claim 1 wherein assigning portions of the GOP bit budget to pictures of type I, P and B includes using the expressions
$${R}_{frame\_target} = \frac{{K}_{pic\_type} {C}_{pic\_type} {R}_{Gop\_remaining}}{\begin{matrix}{K}_{I} {n}_{frame\_I} {C}_{frame\_I} + \\ {K}_{P} {n}_{frame\_P} {C}_{frame\_P} + {K}_{B} {n}_{frame\_B} {C}_{frame\_B}\end{matrix}} for frame$$
pictures and
$${R}_{field\_target} = \frac{{K}_{pic\_type} {C}_{pic\_type} {R}_{Gop\_remaining}}{\begin{matrix}{K}_{I} {n}_{field\_I} {C}_{fieldI} + \\ {K}_{P} ( {n}_{field 0 \_P} {C}_{field 0 \_P} + {n}_{field 1 \_P} {C}_{field 1 \_P} ) + \\ {K}_{B} {n}_{field\_B} {C}_{field\_B}\end{matrix}}$$
for field pictures.

10. The computer-readable medium of claim 1 wherein after assigning a portion of the GOP bit budget to a picture includes updating a remaining number of bits in the GOP bit budget in accordance with the expression R_{GOP}_{_{—}}_{remaining}=R_{GOP}_{_{—}}_{remaining}−R_{target}. where R_{target} is the frame/field target bits of the current picture.

11. The computer-readable medium of claim 1 wherein the step of adjusting the quantization parameter includes determining three virtual buffer fullness, one for each picture of type I, P and B at time t in accordance with
$${d}_{pic\_type} ( t ) = {d}_{pic\_type} ( 0 ) + α \times {B}_{pic\_type} ( t ) - \frac{{\sum }_{i = 0}^{{MB}_{i}} {nbs}_{i}}{total\_nbs} {R}_{pic\_target}$$
where d_{pic}_{_{—}}_{type}(0) is an initial virtual buffer fullness at the beginning of a picture of I, P or B type and d_{pic}_{_{—}}_{type}(t) is the final virtual buffer fullness of the picture, B_{pic}_{_{—}}_{type}(t) is a number of bins generated from coded MBs up to time t, α is the ratio of a total number of actual bits and the total number of bins for a previously-coded picture of the same coding type, and (nbs[i]) is a nominal buffer size for a MB.

12. The computer-readable medium of claim 11 wherein the nominal buffer size (nbs[i]) for a MB is calculated in accordance with
$$\begin{matrix}{nbs}_{i} = \frac{α \times Intra\_Act [ i ] + Intra\_Act \_Ave}{α \times Intra\_Act \_Ave + Intra\_Act [ i ]} \\ = \frac{α \times ( \frac{Intra\_Act [ i ]}{Intra\_Act \_Ave} ) + 1}{α + ( \frac{Intra\_Act [ i ]}{Intra\_Act \_Ave} )}\end{matrix}$$
where the average of the total intra activity (Intra_Act_Ave) is the total activity (Total_Intra_Act) divided by the number of macroblocks in the picture.

13. A video encoder, comprising:
a panel distributor for partitioning pictures in a video stream into a plurality of panels;
a plurality of video panel picture encoders (PPEs) each for compressing one of the plurality of panels;
a packet processor receiving each of the compressed panels and generating therefrom transport packets that include compressed bitstreams;
a rate controller for adjusting at least one encoder parameter to achieve a target bitrate for the compressed bitstreams;
wherein the rate controller is configured to:
estimate a complexity measure of pictures in a GOP in the video stream;
calculate a GOP bit budget for the GOP;
assign portions of the GOP bit budget to the pictures in the GOP based at least in part on the estimated complexity measure; and
adjust the encoder parameter for the picture to achieve the assigned portion of bit budget for each picture in the GOP.

14. The video encoder of claim 13 wherein the rate controller is further configured to prevent encoder and decoder buffers from overflowing or underflowing before encoding a picture in the GOP.

15. The video encoder of claim 14 wherein the rate controller is further configured to prevent the buffers from overflowing or underflowing by estimating a current buffer level.

16. The video encoder of claim 14 wherein the rate controller is further configured to prevent the buffers from overflowing or underflowing by calculating a number of bits in the pictures that do not overflow or underflow the buffers using an end-to-end buffer delay.

17. The video encoder of claim 13 wherein the rate controller is further configured to calculate the GOP bit budget by assuming that a film mode of the GOP is the same as a film mode of a previously processed picture.

18. The video encoder of claim 13 wherein the encoder parameter includes a quantization parameter and the rate controller is further configured to adjust the quantization parameter using a nominal activity measure.

19. The video encoder of claim 13 wherein the rate controller is further configured to estimate the compexity measure by determining the complexity measure of P and B pictures in accordance with the expression
$${C}_{pic\_type} = \frac{W ⊗ {C}_{pic\_type}^{*}}{\sum W} ,$$
where C* is the complexity of a previously encoded picture of the same type and W is a sequence of weightings W={1, 2, 2, 4}.

20. The video encoder of claim 13 wherein the encoder parameter includes a quantization parameter and the rate controller is further configured to adjust the quantization parameter by determining three virtual buffer fullness, one for each picture of type I, P and B at time t in accordance with
$${d}_{pic\_type} ( t ) = {d}_{pic\_type} ( 0 ) + α \times {B}_{pic\_type} ( t ) - \frac{{\sum }_{i = 0}^{{MB}_{i}} {nbs}_{i}}{total\_nbs} {R}_{pic\_target}$$
where d_{pic}_{_{—}}_{type}(0) is an initial virtual buffer fullness at the beginning of a picture of I, P or B type and d_{pic}_{_{—}}_{type}(t) is the final virtual buffer fullness of the picture, B_{pic}_{_{—}}_{type}(t) is a number of bins generated from coded MBs up to time t, α is the ratio of a total number of actual bits and the total number of bins for a previously-coded picture of the same coding type, and (nbs[i]) is a nominal buffer size for a MB.
